(19) United States
(12) Patent Application Publication
(10) Pub. No.: US 2008/0314670 A1
(43) Pub. Date: Dec. 25, 2008

(54) FUEL PUMP MOUNTING FOR A MOTORCYCLE

(75) Inventors: Erik F. Buell, Mukwonago, WI (US); Matthew J. Sheahan, Milwaukee, WI (US)

Correspondence Address: MICHAEL BEST & FRIEDRICH LLP, 100 E WISCONSIN AVENUE, Suite 3300, MILWAUKEE, WI, 53202, US

(73) Assignee: BUELL MOTORCYCLE COMPANY, East Troy, WI (US)

(21) Appl. No.: 11/765,529

(22) Filed: Jun. 20, 2007

(51) Int. Cl. B62K 11/00; F02M 37/10

(52) U.S. Cl. 180/219; 123/509

(57) ABSTRACT

A motorcycle having at least two wheels, a fuel tank for storing fuel, a fuel pump positioned in an opening in the fuel tank, and a retaining clip (e.g., a snap ring, circlip, a cotter pin, a hair pin, a clevis pin, a roll pin, an e-clip, a c-clip, a retainer spring, or a toothed washer) securing the fuel pump in the opening. In one embodiment, the opening is adapted to receive the fuel pump in an axial direction, and the opening is formed by a seal surface (e.g., substantially cylindrical in shape) that is substantially parallel to the axial direction. In this embodiment, the fuel pump includes a pump housing and a gasket (e.g., an O-ring) positioned between the pump housing and the seal surface.

### BACKGROUND

The present invention relates to motorcycles, and particularly to the mounting of a fuel pump on a motorcycle.

Motorcycles commonly include a frame and a fuel tank mounted on the frame. The fuel tank stores fuel for use by the engine. In many modern motorcycles, a fuel is mounted inside the tank for providing the engine with pressured fuel. These fuel pumps typically include a flange that facilitates attaching the fuel pump to the tank with a gasket in between to create a solid, leak-free engagement between the pump and the tank.

### SUMMARY

The present invention provides a motorcycle having at least two wheels, a fuel tank for storing fuel, a fuel pump positioned in an opening in the fuel tank, and a retaining clip (e.g., a snap ring, circlip, a cotter pin, a hair pin, a clevis pin, a roll pin, an e-clip, a c-clip, a retainer spring, or a toothed washer) securing the fuel pump in the opening. In one embodiment, the opening is adapted to receive the fuel pump in an axial direction, and the opening is formed by a seal surface (e.g., substantially cylindrical in shape) that is substantially parallel to the axial direction. In this embodiment, the fuel pump includes a pump housing and a gasket (e.g., an O-ring) positioned between the pump housing and the seal surface.

Other aspects of the invention will become apparent by consideration of the detailed description and accompanying drawings. Before any embodiments of the invention are explained in detail, it is to be understood that the invention is not limited in its application to the details of construction and the arrangement of components set forth in following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### BRIEF DESCRIPTION OF THE DRAWINGS

FIG. 1 is a side view of a motorcycle embodying various aspects of the present invention;

FIG. 2 is an enlarged perspective view of a fuel tank assembly of the motorcycle shown in FIG. 1;

FIG. 3 is an exploded perspective view of fuel tank assembly of FIG. 2, including a tank body, a fuel pump assembly, and a retaining clip;

FIG. 4 is an enlarged rear perspective view of the fuel pump assembly of FIG. 3;

FIG. 5 is a section view taken along line 5-5 of FIG. 2; and

FIG. 6 illustrates other retaining clips that could be used to secure the fuel pump assembly into the tank body.

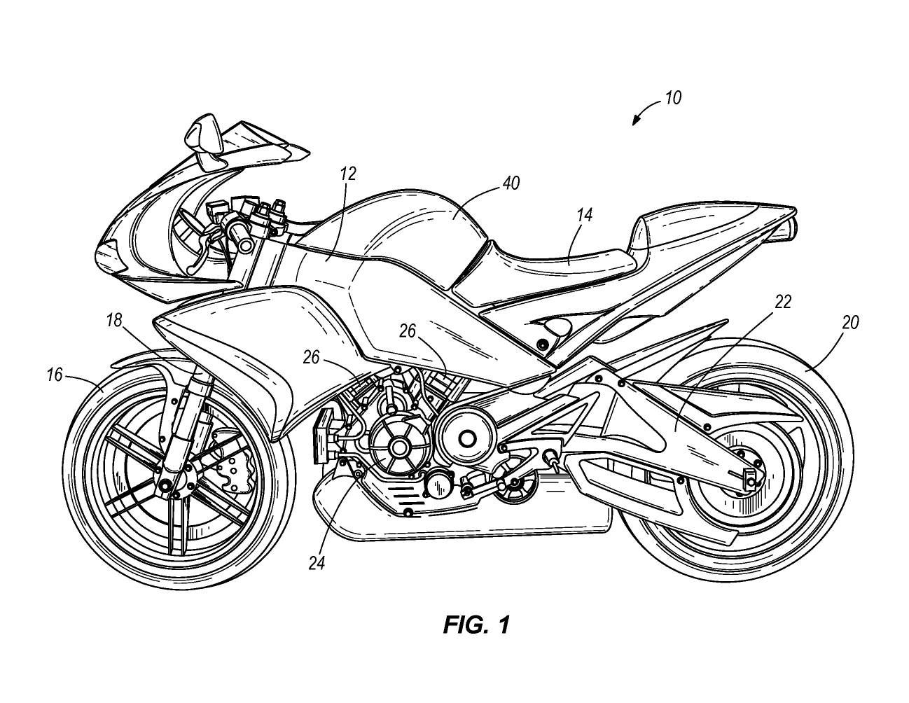

### DETAILED DESCRIPTION

The illustrate motorcycle 10 includes a frame 12, a seat 14, a front wheel 16 supported by a front fork 18, a rear wheel 20 supported by a swing arm 22, and an engine 24. The engine 24 provides power to the rear wheel 20 through a transmission. The engine 24 includes two cylinders 26 for combusting an air-fuel mixture. In the illustrated motorcycle 10, a portion of the frame 12 comprises a fuel tank assembly that stores fuel within the frame 12.

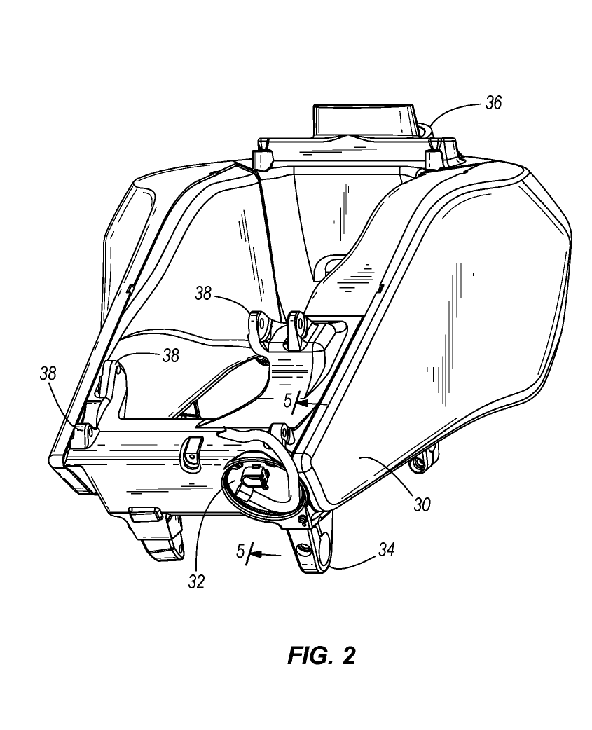

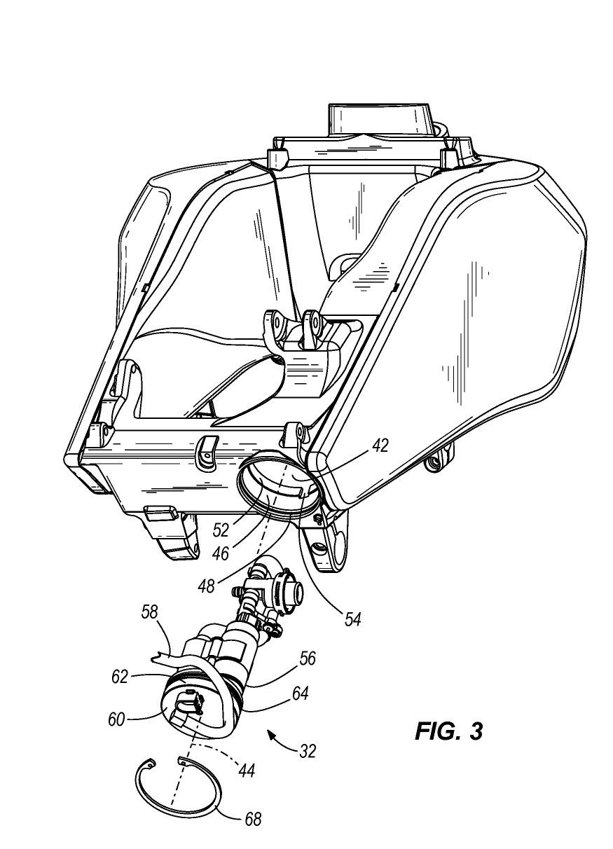

Referring to FIGS. 2 and 3, the illustrated fuel tank assembly includes a tank body 30 and a fuel pump assembly 32 positioned inside the tank body 30. The tank body 30 is formed by a portion of the frame 12 such that the tank body 30 is a structural component of the motorcycle 10. The tank body 30 includes engine mounts 34 that couple the tank body 30 to the engine 24, and a head tube 36 for coupling the tank body 30 to the front fork 18. The tank body 30 further includes upper mounts 38 that facilitate attachment of other components, such as an air box 40, and the seat 14.

The tank body 30 includes a substantially hollow portion that is adapted to receive fuel. The body includes an opening 42 that is adapted to receive the fuel pump assembly 32 in an axial direction 44. The opening 42 is formed by a seal surface 46 that is substantially parallel to the axial direction 44. In the illustrated embodiment, the seal surface 46 is substantially cylindrical in shape. The outer end of the opening 42 is provided with a retention groove 48 that is adapted to receive a retaining clip, as described below in more detail. The inner end of the opening 42 is provided with a ridge 52 that limits the inward insertion of the fuel pump assembly 32 into the opening 42. The ridge 52 includes an orientation slot 54 that is adapted to orient the fuel pump assembly 32 in the opening 42, as described below in more detail.

The fuel pump assembly 32 includes a pump housing 56 and various pump components (not shown) inside the housing 56. A fuel line 58 is coupled to the housing 56 to facilitate delivery of fuel from the fuel pump assembly 32 to the fuel supply system (e.g., fuel injectors) of the engine 24.

The illustrated housing 56 includes a plug portion 60 that is dimensioned to fit in the opening 42 of the tank body 30. The plug portion 60 is substantially cylindrical in shape and has a cylindrical outer surface 62. The plug portion 60 includes two O-ring 64 positioned within two seal grooves on the cylindrical outer surface 62. The dimensions of the plug portion 60 and the positioning of the O-rings 64 provides a sealed engagement between the pump housing 56 and the seal surface 46 of the tank body 30.

The pump housing 56 is also provided with an orientation tab 66 that ensures proper rotational orientation of the housing 56 relative to the tank body 30. The orientation tab 66 is dimensioned so that it will not pass over the ridge 52, but will fit in the orientation slot 54 when properly aligned with the orientation slot 54. By virtue of the orientation tab 66 and the orientation slot 54, the fuel pump assembly 32 must be positioned in the proper rotational orientation in order to be inserted into the opening 42 of the tab body 32.

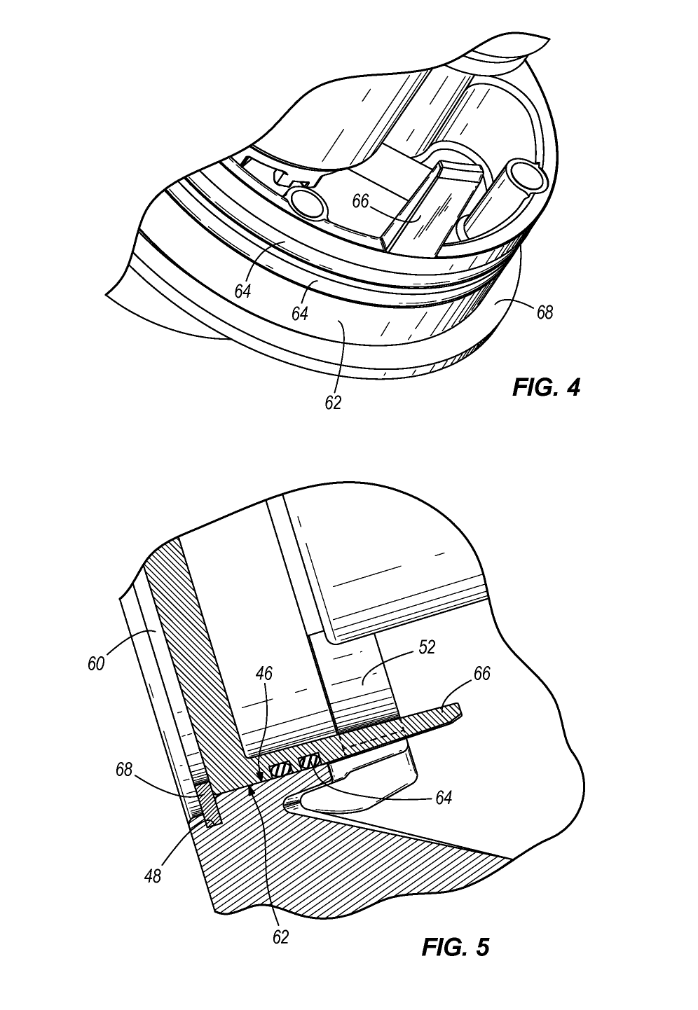

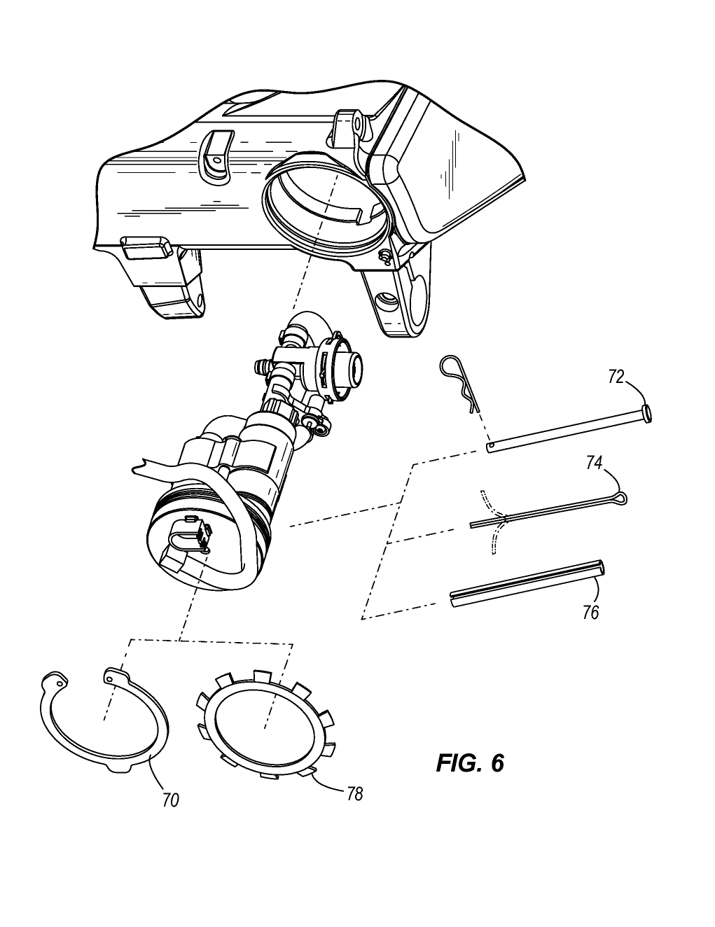

In the illustrated embodiment, a retaining clip in the form of a snap ring 68 is utilized to secure the fuel pump assembly 32 in the opening 42 of the tank body 30. The snap ring 68 is dimensioned to fit within the retention groove 48 near the outermost portion of the body 30. As used herein, a retaining clip is a non-threaded member that secures the fuel pump assembly by holding it into the opening, as distinguished from a bolt or a screw, which secures objects by pressing the object into engagement with another object. It should be understood that the retaining clip can be in the form of non-threaded fasteners other than a snap ring, such as a circlip 70, a cotter pin 72, a hair pin 74, a clevis pin, a roll pin 76, an e-clip, a c-clip, a retainer spring, or a toothed washer 78 (FIG. 5). For any of the retaining clips that are in the form of a pin, a corresponding hole(s) would be provided in the tank body 30 near the opening 42.

During assembly, the fuel pump assembly 32 is inserted into the opening 42 of the tank body 30 along the axial direction 44. As the plug portion 60 starts to enter the opening 42, the fuel pump assembly 32 is rotated to axially align the orientation tab 66 on the fuel pump assembly 32 with the orientation slot 54 on the tank body 30. The fuel pump assembly 32 is then further inserted into the opening 42 until the plug portion 60 passes the retention groove 48 in the tank body. The snap ring 68 is then installed into the retention groove 48 to secure the fuel pump assembly 32 in the tank body 30.

What is claimed is:

1. A motorcycle comprising:
at least two wheels;
a fuel tank for storing fuel, the fuel tank including a opening;
a fuel pump positioned in the opening; and
a retaining clip securing the fuel pump in the opening.

2. The motorcycle assembly of claim 1, wherein the fuel tank comprises a structural portion of a frame of the motorcycle.

3. The motorcycle of claim 1, wherein the opening is adapted to receive the fuel pump in an axial direction, and wherein the opening is formed by a seal surface that is substantially parallel to the axial direction, and wherein the fuel pump includes a pump housing and a gasket positioned between the pump housing and the seal surface.

4. The motorcycle of claim 3, wherein the gasket comprises an O-ring.

5. The motorcycle of claim 3, wherein the seal surface is substantially cylindrical in shape.

6. The motorcycle of claim 1, wherein the retaining clip is selected from the group consisting a snap ring, circlip, a cotter pin, a hair pin, a clevis pin, a roll pin, an e-clip, a c-clip, a retainer spring, or a toothed washer.

7. A fuel tank assembly comprising:
a fuel tank for storing fuel, the fuel tank including a opening;
a fuel pump positioned in the opening; and
a retaining clip securing the fuel pump in the opening.

8. The fuel tank assembly of claim 7, wherein the fuel tank comprises a structural portion of a frame of a motorcycle.

9. The fuel tank assembly of claim 7, wherein the opening is adapted to receive the fuel pump in an axial direction, and wherein the opening is formed by a seal surface that is substantially parallel to the axial direction, and wherein the fuel pump includes a pump housing and a gasket positioned between the pump housing and the seal surface.

10. The fuel tank assembly of claim 9, wherein the gasket comprises an O-ring.

11. The fuel tank assembly of claim 9, wherein the seal surface is substantially cylindrical in shape.

12. The fuel tank assembly of claim 7, wherein the retaining clip is selected from the group consisting of a snap ring, circlip, a cotter pin, a hair pin, a clevis pin, a roll pin, an e-clip, a c-clip, a retainer spring, or a toothed washer.
